(19) United States
(12) Patent Application Publication
(10) Pub. No.: US 2020/0283024 A1
(43) Pub. Date: Sep. 10, 2020

(54) VEHICLE, INFORMATION PROCESSING APPARATUS, CONTROL METHODS THEREOF, AND SYSTEM

(71) Applicant: HONDA MOTOR CO., LTD., Tokyo (JP)

(72) Inventor: Shun IWASAKI, Wako-shi (JP)

(21) Appl. No.: 16/883,450

(22) Filed: May 26, 2020

Related U.S. Application Data
(63) Continuation of application No. PCT/JP2017/042504, filed on Nov. 28, 2017.

(51) Int. Cl. B60W 60/00; B60W 40/04; G08G 1/00

(52) U.S. Cl. CPC B60W 60/0025; B60W 40/04; B60W 2554/80; B60W 2556/45; B60W 2420/42; G08G 1/22

(57) ABSTRACT

The present invention provides a vehicle comprising: a detection unit configured to detect peripheral information of a periphery of a self-vehicle; a communication unit configured to communicate with an external apparatus; a specification unit configured to specify, based on the peripheral information detected by the detection unit, a region that cannot be detected in the periphery of the self-vehicle; an obtaining unit configured to obtain, from peripheral information which has been detected by an object and is accumulated in the external apparatus, information of the region specified by the specification unit, via the communication unit; and a generation unit configured to generate, by using the peripheral information detected by the detection unit and the information obtained by the obtaining unit, information to perform travel control of the self-vehicle.

### CROSS-REFERENCE TO RELATED APPLICATION(S)

This application is a continuation of International Patent Application No. PCT/JP2017/042504 filed on Nov. 28, 2017, the entire disclosures of which is incorporated herein by reference.

### TECHNICAL FIELD

The present invention relates to a vehicle control technique.

### BACKGROUND ART

Conventionally, a vehicle that performs travel support includes a plurality of detection units for collecting information of a peripheral environment. The vehicle determines a driving position or a travel condition of the self-vehicle based on the detection results of these detection units.

For example, in PTL 1, there is disclosed that a transmission-side navigation system will transmit a warning position to a reception-side navigation system via a wireless network, and the reception-side navigation system will plan an alternative path to avoid the warning position. There is also disclosed that the warning position can be transmitted/received via a server.

### CITATION LIST

### Patent Literature

PTL 1: Japanese PCT National Publication No. 2011-503625

### SUMMARY OF INVENTION

### Technical Problem

When a vehicle is traveling, there is a range that cannot be detected by the detection units included in the self-vehicle depending on changes in the environment, other vehicles and objects positioned in the periphery of the travel position of the self-vehicle, and the like. For example, in a road that has a plurality of lanes, if there is another vehicle traveling on an adjacent lane, it is difficult for the detection units to detect a region on a side further beyond this adjacent lane because the region will be shielded by the other vehicle (so-called occlusion). It may also be difficult to detect/recognize, at an early stage, another vehicle approaching at an intersection or the like when the field of view is shielded by a building or the like.

When automated driving is performed, a more suitable travel control operation can be performed by recognizing the presence of another vehicle or the like at an earlier stage. However, in the cases as described above, since the other vehicle or the like cannot be recognized until immediately before, the accuracy of travel support is reduced, and the delay in the obtainment of peripheral information increases the risk related to travel.

Hence, an object of the present invention is to improve the accuracy of travel support by obtaining, even in a case in which a region that cannot be recognized from the position of the self-vehicle is present, the information of the region.

### Solution to Problem

To solve the above-described problem, the present invention includes the following arrangement. That is, there is provided a vehicle comprising: a detection unit configured to detect peripheral information of a periphery of a self-vehicle; a communication unit configured to communicate with an external apparatus; a specification unit configured to specify, based on the peripheral information detected by the detection unit, a region that cannot be detected in the periphery of the self-vehicle; an obtaining unit configured to obtain, from peripheral information which has been detected by an object and is accumulated in the external apparatus, information of the region specified by the specification unit, via the communication unit; and a generation unit configured to generate, by using the peripheral information detected by the detection unit and the information obtained by the obtaining unit, information to perform travel control of the self-vehicle.

### Advantageous Effects of Invention

According to the present invention, the accuracy of travel support can be improved by obtaining, even in a case in which a region that cannot be recognized from a self-vehicle is present, information of the region.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a block diagram of a vehicle control system according to an embodiment of the present invention;

FIG. 2 is a view showing an example of a system arrangement according to the present invention;

FIG. 3 is a view for explaining a peripheral environment of a vehicle according to the present invention;

FIG. 4 is a view for explaining a detection region and information of each vehicle according to the present invention;

FIG. 5 is a flowchart showing a processing sequence according to the first embodiment; and

FIG. 6 is a flowchart showing a processing sequence according to the second embodiment.

### DESCRIPTION OF EMBODIMENTS

An embodiment according to the present invention will be described hereinafter with reference to the accompanying drawings. Note that arrangements and the like to be illustrated below are merely examples and do not limit the present invention.

[Vehicle Arrangement]

An example of the arrangement of a vehicle control system related to automated driving that is applicable to the present invention will be described first.

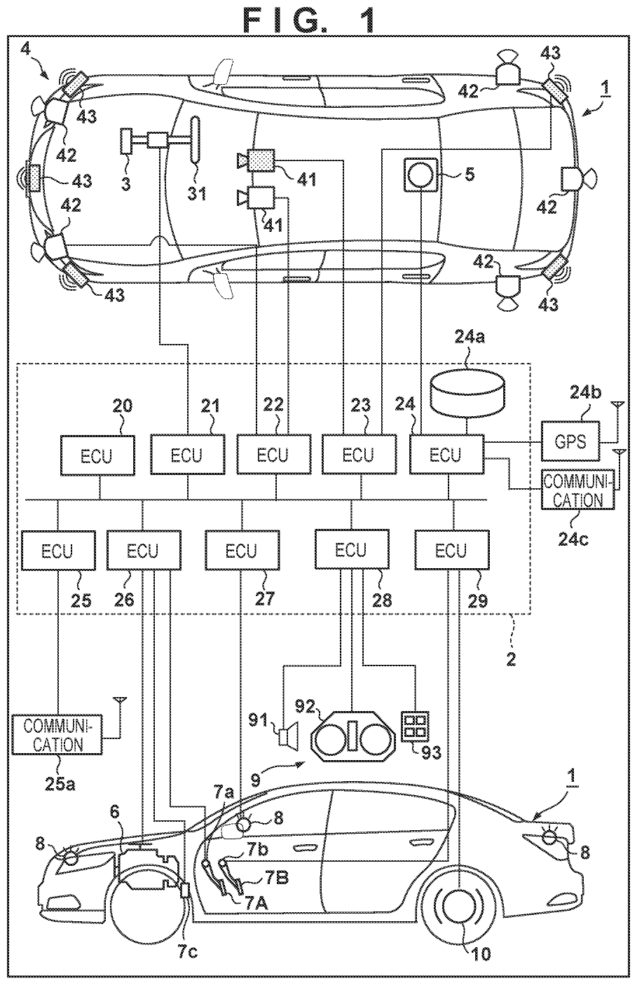

FIG. 1 is a block diagram of a vehicle control apparatus according to an embodiment of the present invention and controls a vehicle 1. FIG. 1 shows the outline of the vehicle 1 by a plan view and a side view. The vehicle 1 is, for example, a sedan-type four-wheeled vehicle.

The control apparatus shown in FIG. 1 includes a control unit 2. The control unit 2 includes a plurality of ECUs 20 to 29 communicably connected by an in-vehicle network. Each ECU (Electronic Control Unit) includes a processor represented by a CPU (Central Processing Unit), a storage device such as a semiconductor memory, an interface with an external device, and the like. The storage device stores programs to be executed by the processor, data to be used by the processor for processing, and the like. Each ECU may include a plurality of processors, storage devices, and interfaces.

The functions and the like provided by the ECUs 20 to 29 will be described below. Note that the number of ECUs and the provided functions can be appropriately designed, and the) can be subdivided or integrated as compared to this embodiment.

The ECU 20 executes control associated with automated driving of the vehicle 1. In automated driving, at least one of steering and acceleration/deceleration of the vehicle 1 is automatically controlled. In a control example to be described later, both steering and acceleration/deceleration are automatically controlled.

The ECU 21 controls an electric power steering device 3. The electric power steering device 3 includes a mechanism that steers front wheels in accordance with a driving operation (steering operation) of a driver on a steering wheel 31. In addition, the electric power steering device 3 includes a motor that generates a driving force to assist the steering operation or automatically steer the front wheels, and a sensor that detects the steering angle. If the driving state of the vehicle 1 is automated driving, the ECU 21 automatically controls the electric power steering device 3 in correspondence with an instruction from the ECU 20 and controls the direction of travel of the vehicle 1.

The ECUs 22 and 23 perform control of detection units 41 to 43 that detect the peripheral state of the vehicle and information processing of detection results. Each detection unit 41 is a camera (to be sometimes referred to as the camera 41 hereinafter) that captures the front side of the vehicle 1. In this embodiment, two cameras are attached to the windshield inside the vehicle cabin at the roof front portion of the vehicle 1. When images captured by the cameras 41 are analyzed, the contour of an object or a division line (a white line or the like) of a lane on a road can be extracted.

The detection unit 42 is Light Detection and Ranging (LIDAR) (to be sometimes referred to as the LIDAR 42 hereinafter), and detects a target around the vehicle 1 or measures the distance to an object. In this embodiment, five LIDARs 42 are provided; one at each corner of the front portion of the vehicle 1, one at the center of the rear portion, and one on each side of the rear portion. The detection unit 43 is a millimeter wave radar (to be sometimes referred to as the radar 43 hereinafter), and detects an object around the vehicle 1 or measures the distance to an object. In this embodiment, five radars 43 are provided; one at the center of the front portion of the vehicle 1, one at each corner of the front portion, and one at each corner of the rear portion. Assume that the detectable range and information will change in accordance with the type, the installation position, the installation angle, and the like of each detection unit.

The ECU 22 performs control of one camera 41 and each LIDAR 42 and information processing of detection results. The ECU 23 performs control of the other camera 41 and each radar 43 and information processing of detection results. Since two sets of devices that detect the peripheral state of the vehicle are provided, the reliability of detection results can be improved. In addition, since detection units of different types such as cameras, LIDARs, and radars are provided, the peripheral environment of the vehicle can be analyzed multilaterally. Furthermore, even in a case in which a detection result of one detection unit cannot be obtained or in a case in which the accuracy of the detection unit has decreased, it is possible to complement the detection result by using a detection result of another detection unit.

The ECU 24 performs control of a gyro sensor 5, a GPS sensor 24b, and a communication device 24c and information processing of detection results or communication results. The gyro sensor 5 detects a rotary motion of the vehicle 1. The course of the vehicle 1 can be determined based on the detection result of the gyro sensor 5, the wheel speed, or the like. The GPS sensor 24b detects the current position of the vehicle 1. The communication device 24c performs wireless communication with a server that provides map information and traffic information and acquires these pieces of information. The ECU 24 can access a map information database 24a formed in the storage device. The ECU 24 searches for a path from the current position to the destination.

The ECU 25 includes a communication device 25a for inter-vehicle communication. The communication device 25a performs wireless communication with another vehicle on the periphery and performs information exchange between the vehicles.

The ECU 26 controls a power plant 6. The power plant 6 is a mechanism that outputs a driving force to rotate the driving wheels of the vehicle 1 and includes, for example, an engine and a transmission. The ECU 26, for example, controls the output of the engine in correspondence with a driving operation (accelerator operation or acceleration operation) of the driver detected by an operation detection sensor 7a provided on an accelerator pedal 7A, or switches the gear ratio of the transmission based on information such as a vehicle speed detected by a vehicle speed sensor 7c. If the driving state of the vehicle 1 is automated driving, the ECU 26 automatically controls the power plant 6 in correspondence with an instruction from the ECU 20 and controls the acceleration/deceleration of the vehicle 1.

The ECU 27 controls lighting devices (headlights, taillights, and the like) including direction indicators 8 (turn signals). In the example shown in FIG. 1, the direction indicators 8 are provided in the front portion, door mirrors, and the rear portion of the vehicle 1.

The ECU 28 controls an input/output device 9. The input/output device 9 outputs information to the driver and accepts input of information from the driver. A voice output device 91 notifies the driver of the information by voice. A display device 92 notifies the driver of information by displaying an image. The display device 92 is arranged, for example, in the front surface of the driver's seat and constitutes an instrument panel or the like. Note that although a voice and display have been exemplified here, the driver may be notified of information using a vibration or light. Alternatively, the driver may be notified of information by a combination of some of the voice, display, vibration, and light. Furthermore, the combination or the notification form may be changed in accordance with the level (for example, the degree of urgency) of information of which the driver is to be notified.

An input device 93 is a switch group that is arranged at a position where the driver can perform an operation, is used to issue an instruction to the vehicle 1, and may also include a voice input device.

The ECU 29 controls a brake device 10 and a parking brake (not shown). The brake device 10 is, for example, a disc brake device which is provided for each wheel of the vehicle 1 and decelerates or stops the vehicle 1 by applying a resistance to the rotation of the wheel. The ECU 29, for example, controls the operation of the brake device 10 in correspondence with a driving operation (brake operation) of the driver detected by an operation detection sensor 7b provided on a brake pedal 7B. If the driving state of the vehicle 1 is automated driving, the ECU 29 automatically controls the brake device 10 in correspondence with an instruction from the ECU 20 and controls deceleration and stop of the vehicle 1. The brake device 10 or the parking brake can also be operated to maintain the stop state of the vehicle 1. In addition, if the transmission of the power plant 6 includes a parking lock mechanism, it can be operated to maintain the stop state of the vehicle 1.

### First Embodiment

Control according to the present invention will be described below.

[System Arrangement]

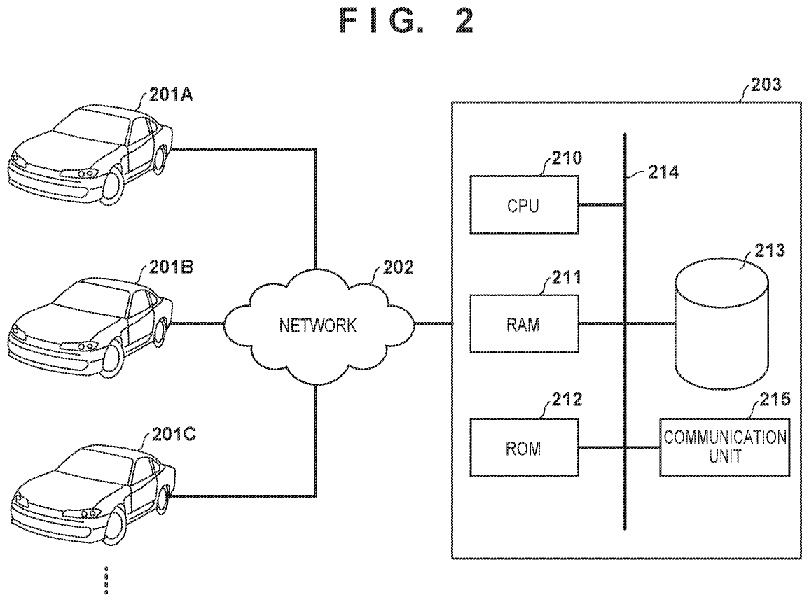

FIG. 2 is a view showing an example of a system arrangement according to this embodiment. In this embodiment, a plurality of vehicles 201 (201A, 201B, 201C . . . ) and a server 203 are communicably connected to each other via a network 202. Each of the plurality of vehicles 201 includes an arrangement as that described above with reference to FIG. 1. Note that all of vehicles 201 need not have the same arrangement. The arrangement of the network 202 is not particularly limited, and the method by which each vehicle 201 connects to the network 202 is also not particularly limited. For example, it may be set so that the communication method will be automatically switched in accordance with the data amount, the communication speed, or the like at the time of communication.

The server 203 collects various kinds of information from each of the plurality of vehicles 201 and manages the collected information. In addition, the server provides the managed information in response to a request from each of the plurality of vehicles 201. The server 203 includes a CPU 210, a RAM 211, a ROM 212, an external storage device 213, and a communication unit 215, and these components are communicably connected to each other via a bus 214 in the server 203. The CPU 210 reads out and executes a program stored in the ROM 212 or the like to control the overall operation of the server 203. The RAM 211 is a volatile storage area and is used as a work memory or the like. The ROM 212 is a nonvolatile storage area. The external storage device 213 is a nonvolatile storage area and holds programs and databases for managing various kinds of data according to this embodiment. The communication unit 215 is a part for communicating with each of the plurality of vehicles 201 and is in charge of communication control.

Note that although only one server 203 is shown in FIG. 2, the present invention is not limited to this. A plurality of servers may be used to distribute the load and to collect, manage, and provide data. Also, it may be arranged so that the external storage device 213 to be used as a database will be provided separately from the server 203. In addition, each part may be arranged to include a plurality of parts.

[Peripheral Environment at Time of Travel]

As an example of travel control performed by a vehicle, there are control operations for the travel position, travel speed, the distances from the self-vehicle to preceding and following vehicles, and the like. When performing these travel control operations, the vehicle obtains the peripheral information of a predetermined range of the self-vehicle. In this predetermined range, various kinds of ranges are defined in accordance with the characteristics and arrangements of the respective detection units. In this case, assume that the vehicle holds, in advance, each range that can be detected as a detection range. Assume also that, when an object, an obstacle, or the like is positioned in the range, the vehicle can recognize that detection of a region beyond the object, the obstacle, or the like is impossible. That is, assume that the vehicle can recognize that an occlusion has occurred in the peripheral region of the vehicle. In addition, assume that the position of this region can be specified by its relative relationship with the position of the self-vehicle.

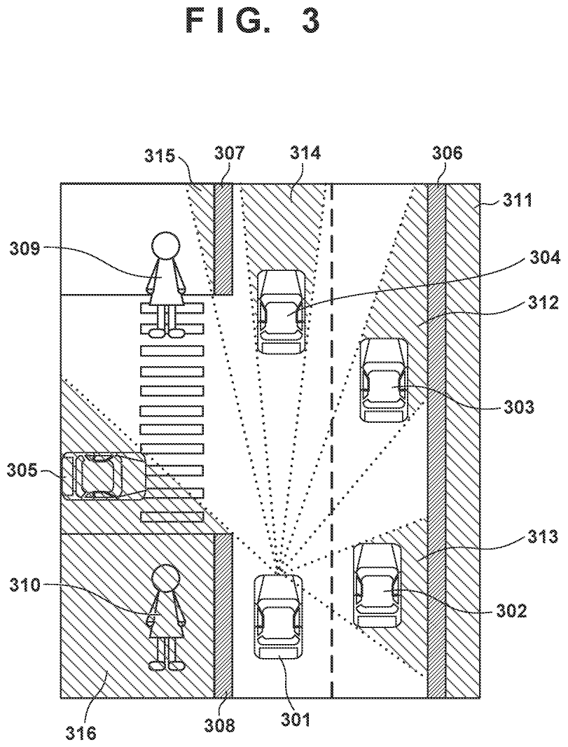

FIG. 3 is a view for explaining the peripheral environment at the time of travel of the self-vehicle according to this embodiment. For the sake of descriptive convenience, a description will be given by setting a vehicle 301 as the self-vehicle, and using a plan view. Note that the detection is not limited to performing detection in a planar manner, and the detection may be performed in a three-dimensional manner.

In FIG. 3, a description will be given by assuming that four vehicles 302 to 305 and persons 309 and 310 are present in the periphery of the vehicle 301. In addition, a state in which the vehicle 301 is traveling straight and a road to which the vehicle is to merge is present in the front right side of the vehicle in the direction of travel. Furthermore, assume that objects 306 to 308 such guardrails or the like are present on the left and right sides of the vehicle 301. The dotted lines in FIG. 3 are illustrated for the convenience of describing the detection range of the self-vehicle.

In the example shown in FIG. 3, regions 311, 315, and 316 are blind spots (to be referred to as blind spot regions hereinafter) due to the presence of the objects 306 to 308, and information of the regions 311, 315, and 316 cannot be obtained from the current position of the vehicle 301. Furthermore, due to the presence of the vehicles 302 to 304, regions 312, 313, and 314 are blind spot regions, and information of the regions 312, 313, and 314 cannot be obtained from the current position of the vehicle 301. Hence, the vehicle 301 cannot use the information of the undetectable regions for travel control.

For example, since the person 309 is present in a range that can be detected by the vehicle 301, travel control can be performed in consideration of the presence of this person. On the other hand, since the vehicle 305 and the person 310 are present in a blind spot region, their presence cannot be detected. Hence, if the vehicle 305 makes an entry at a merge position, there will be a delay in an avoidance operation if the self-vehicle cannot detect this entry until immediately before. Furthermore, it will be impossible to perform travel control to a travel position determined by predicting the entry in advance. In contrast, if the self-vehicle can detect the presence of the vehicle 305 at an early stage, the self-vehicle will be able to perform control in advance to move the travel position to a position away from the position where the roads merge.

Hence, in this embodiment, in addition to the peripheral information detected by the self-vehicle, peripheral information detected by another vehicle and peripheral information detected by a predetermined object will be obtained and used as peripheral information of a region (blind spot region) that could not be detected by the self-vehicle. This will allow travel control to be performed more appropriately. A predetermined object in this case corresponds to a camera or the like arranged at a position facing a road. The following explanation will be made by using an example of peripheral information detected by a vehicle.

[Arrangement of Peripheral Information]

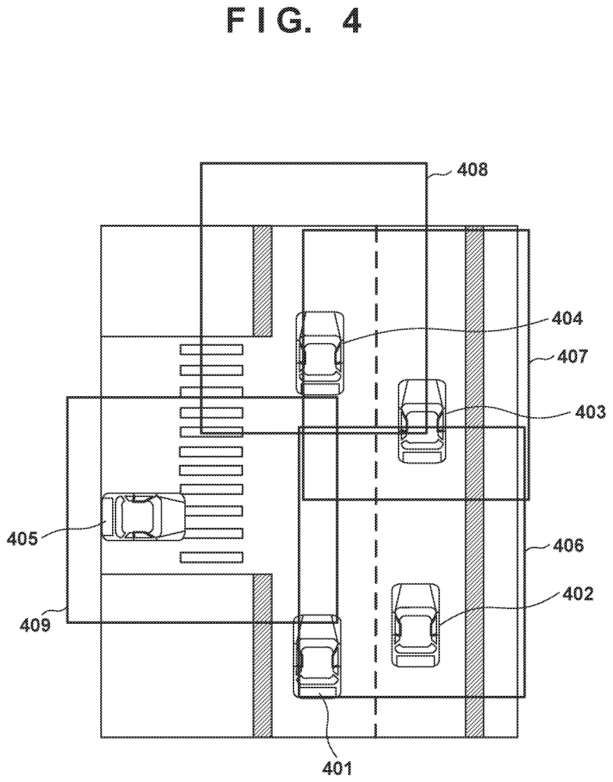

FIG. 4 is a view for explaining the concept of peripheral information which is obtained by another vehicle and used in the embodiment. In FIG. 4, four vehicle 402 to 405 are present as other vehicles in the periphery of a vehicle 401 as the self-vehicle. A range 406 is a range that can be detected by the detection units included in the vehicle 402. Also, a range 407 is a range that can be detected by the detection units included in the vehicle 403. Also, a range 408 is a range that can be detected by the vehicle 404. Also, a range 409 is a range that can be detected by the vehicle 405. That is, the vehicles 402 to 405 can detect different ranges from each other. The detection results obtained from these ranges can be used to complement the information of the region that could not be detected by the vehicle 401. Regions that could not be detected by each of the vehicles 402 to 405 due to an obstacle or the like have been omitted for the sake of descriptive convenience.

Information of the range detected by each vehicle is transmitted, to the server 203, together with the position information and the like of the vehicle. The server 203 manages the information transmitted from each vehicle by associating the transmitted information with the information of each vehicle. At this time, the server 203 may also manage the reception time and the information of the time of the detection by each vehicle.

Furthermore, in response to a request from each vehicle, the server 203 will extract and provide, from the information which is being managed, information related to the periphery of the vehicle which made the request. The information to be provided in this case may be the periphery information of the current position of the vehicle which made the request or may be periphery information of a planned travel path. In addition, it may be set so that information of a position close to the vehicle which made the request will be preferentially provided or information related to a specific object will be preferentially provided. A specific object in this case can be, for example, a person, an object positioned on the road, or the like. Information to be transmitted may also be finely searched from the relationship between the communication rate and the data amount. Furthermore, it may set so that information will be provided by integrating information that has been collected on the side of the server 203 and organizing the information as another piece of information. For example, it may be arranged so that, for example, pieces of collected information (events and the like) will be mapped onto pre-held map information. Subsequently, this map information may be provided to each vehicle.

[Processing Sequence]

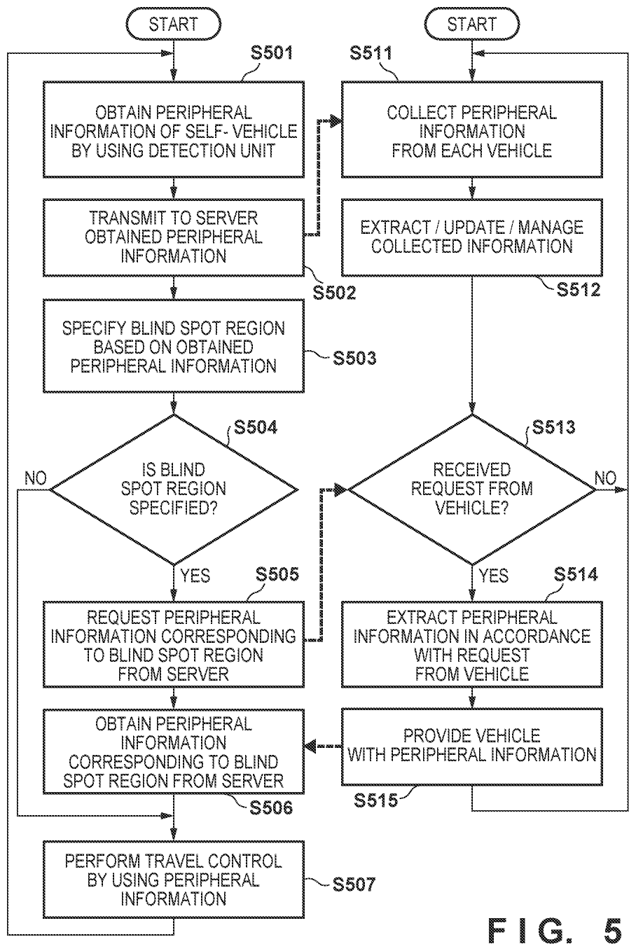

A processing sequence according to the embodiment will be described hereinafter. This processing shows an arrangement to be executed by each vehicle 201 and the server 203. In FIG. 5, processing to be executed by the server 203 is illustrated on the right side, and processing to be executed by each vehicle 201 is illustrated on the left side. A dotted line arrow represents transmission/reception of data in FIG. 5.

Processing performed on the side of the vehicle will be described first. Note that, transmission/reception of data is performed between the plurality of vehicles 201 and the server 203 as shown in FIG. 2, and an example of one vehicle 201 will be described here. Although processing of each vehicle 201 is performed by the cooperation of a plurality of devices such as the ECUs, the communication device, and the like, the vehicle 201 will be denoted as the main subject of processing for the sake of descriptive convenience in this case.

In step S501, the vehicle 201 obtains information (to be referred to as peripheral information hereinafter) of the peripheral environment by using the plurality of detection units included in the self-vehicle. The type and arrangement of information to be obtained here are not particularly limited and can be changed in accordance with the arrangement of the vehicle.

In step S502, the vehicle 201 transmits, to the server 203, the peripheral information detected in step S501. In this case, peripheral information to be transmitted may be arranged so that all of the pieces of information detected by the detection units will be transmitted or only information detected by a specific unit will be transmitted. It may also be arranged so that the data to be transmitted may be limited in accordance with the data rate and the data amount or important information will be prioritized and sequentially transmitted by setting a priority to the data. The priority setting method is not particularly limited. At this time, position information and information for identifying the self-vehicle and the like may be transmitted together as well. In addition, time information of the detection may also be included in the information to be transmitted.

In step S503, the vehicle 201 specifies each region (blind spot region) that could not be detected by the detection units based on the peripheral information obtained in step S501. The blind spot regions in this case correspond to regions described with reference to FIG. 3. Also, it may be arranged so that information of a range which can be detected by the self-vehicle will be held in advance, and each region outside this range will be handled as a blind spot region. For example, since the detection accuracy of each detection unit will decrease as the distance from the installation position increases, a position away from the detection unit by a predetermined distance may be handled as a blind spot region even when an obstacle is not present. Alternatively, the periphery of the self-vehicle may be defined by dividing the periphery into several regions, and determination as to whether a blind spot region is included in each region may be performed. For example, as the granularity of the division, the periphery can be divided in to 8 regions which are at a front side, a front left side, a front right side, a left side, a right side, a rear side, a rear left side, and a rear right side of the self-vehicle.

In step S504, the vehicle 201 determines whether a blind spot region has been specified in step S503. If a blind spot region has been specified (YES in step S504), the process advances to step S505. If a blind spot region has not been specified (NO in step S504), the process advances to step S507.

In step S505, the vehicle 201 transmits a peripheral information obtainment request to the server 203. In this case, the vehicle 201 may transmit a request for only the blind spot regions within a predetermined range (distance) based on the current position and the travel speed or the like of the self-vehicle. Alternatively, a request can be made to obtain the peripheral information of a planned travel path. In addition, the current position of the self-vehicle may be used as a reference, and the type of peripheral information to be requested may be changed in accordance with the distance from the current position. For example, image data may be requested for each blind spot region in a predetermined region, and a more simplified piece of information may be requested for each blind spot region outside the predetermined range.

In step S506, the vehicle 201 obtains peripheral information as a response to the obtainment request transmitted in step S505. Regarding the peripheral information in this case, the self-vehicle need not stand by to receive all of the pieces of the requested information. For example, in a case in which a predetermined time has elapsed since the obtainment request has been transmitted or in a case in which the self-vehicle has moved away by a predetermined distance or more from the position where the self-vehicle transmitted the obtainment request, data obtainment corresponding to the obtainment request may be canceled even if the requested information has not been received. This is in consideration of the fact that the state of the peripheral environment will change as time passes in accordance with the transmitted/received data amount, the communication state, the travel speed and the travel position of the self-vehicle, and the like.

In step S507, the vehicle 201 uses the peripheral information obtained in step S501 and the peripheral information obtained in step S506 to generate information related to travel control. The vehicle 201 will use the generated information to perform travel control of the self-vehicle. The contents of travel control are not particularly limited, and for example, speed control, travel position change, travel path change, and the like can be performed. Note that in a case in which data is not obtained in step S506 (for example, in a case in which a blind spot region is absent), only the peripheral information detected by the detection units of the self-vehicle will be used. Subsequently, the process will return to step S501. Note that this processing sequence will end in a case in which an instruction is made to end automated driving or travel support control.

Processing to be performed on the side of the server 203 will be described next.

In step S511, the server 203 obtains the peripheral information transmitted from each vehicle.

In step S512, the server 203 extracts the peripheral information collected in step S512 so as to make the peripheral information correspond with a predetermined arrangement, and accumulates the peripheral information in a database (the external storage device 213). In this case, the accumulation method is not particularly limited, and may be specified in accordance with the processing speed and the data amount. Also, past peripheral information may be deleted in a case in which a predetermined time has elapsed since the collection of the peripheral information.

In step S513, the server 203 determines whether a peripheral information obtainment request has been received from any of the vehicles. If an obtainment request has been received (YES in step S513), the process advances to step S514. If an obtainment request has not been received (NO in step S513), the process returns to step S511.

In step S514, the server 203 extracts, in accordance with the obtainment request received from a vehicle, the peripheral information to be provided from the peripheral information that is being managed. In this case, the contents of the information to be transmitted or the transmission order of the information may be determined in accordance with the communication rate, communication state, and the data amount.

In step S515, the server 203 transmits, to the vehicle, the information extracted in step S514 as a response to the obtainment request. Note that it may be arranged so that the transmission of information will be canceled in accordance with the time (for example, elapsed time since the start of transmission) required for the transmission or so as to cancel the transmission of old information and transmit updated information in a case in which information of a corresponding region has been updated. Subsequently, the process returns to step S511.

Note that even in a case in which automated driving or travel control is not performed (that is, in a case in which manual driving is performed), each vehicle may obtain the peripheral information of the self-vehicle at a suitable time and transmit the obtained peripheral information to the server 203. That is, the processes of steps S501 and S502 of FIG. 5 may be executed constantly regardless of whether automated driving or travel support has been executed.

In addition, assume that the server 203 will receive, update, and manage the peripheral information each time the peripheral information is transmitted from each of the plurality of vehicles. That is, assume that the processes of steps S511 and S512 of FIG. 5 will be constantly performed when transmission from a vehicle is being continued.

Also, in an obtainment request (step S503) from a vehicle, for example, in a case in which another vehicle is traveling in a region which is at the left front of the self-vehicle, it will be determined that a region beyond this region cannot be detected. Hence, it may be set so that the vehicle will request only the information of a region at the left front side of the self-vehicle. In this case, since the self-vehicle and the other vehicle are traveling, the region in which the data will be obtained with further detail may be limited in accordance with the relative speed, the direction of travel, or the like.

For example, in a case in which the self-vehicle is traveling straight, control may be performed to prioritize the information of blind spot regions at the front while reducing the priority of information about the left and right sides of the self-vehicle. Also, in a case in which the data amount or the communication load is restricted, it may be arranged so that information of a range up to a predetermined position from the self-vehicle will be obtained with higher priority. More specifically, it may be set so that information of regions closer to the position of the self-vehicle will be requested with higher priority. In addition, the periphery of the self-vehicle may be divided into several regions in advance, and only the peripheral information corresponding to a divided region may be requested. It may also be arranged so that an obtainment request will be transmitted regardless of the travel state of the vehicle such as during traveling, during a temporary stop, or the like. In addition, it may be arranged so that peripheral information related to a moving object or a person will be obtained with higher priority.

In addition, the format of the data to be transmitted/received may be switched in accordance with the priority. For example, image data obtained by a camera may be transmitted/received for peripheral information which has high priority, and information which has low priority and information of a position farther than that of a predetermined threshold may be transmitted/received by another data format.

In addition, it may be arranged so that the peripheral information will be transmitted together with information (the travel path and the positional relationship with the self-vehicle) of another vehicle that has been obtained.

Also, in a case in which the server is to manage the peripheral information of each vehicle, the collected peripheral information may be managed for each area by mapping the collected peripheral information on a map. The granularity of each area is not particularly limited, and for example, map information that is formed by having a granularity of 0.1 m×0.1 m basis may be used. Furthermore, each vehicle and the server may hold corresponding map information and may exchange information based on this map information.

In addition, when the server has newly received information of the same region in relation to the information collected from each vehicle, it may be arranged so that the information related to the region will be updated or the information may be held as history for a predetermined period. It may also be arranged so that a degree of reliability will be set to each piece of information collected from each vehicle, and the degree of reliability may be reduced with respect to a piece of information of a given region in accordance with the time that has elapsed since the reception of this piece of information. Alternatively, in a case in which the same detection result is obtained from a plurality of vehicles with respect to a given region, the degree of reliability of this information may be increased. Furthermore, in a case in which the same detection result is obtained from a predetermined number of vehicles, the contents of this detection result may be handled as information which can be shared with other vehicles.

As described above, according to this embodiment, even in a case in which regions that cannot be detected by the detection units included in the self-vehicle are present, it is possible to perform appropriate control by using information detected by another vehicle.

### Second Embodiment

In the first embodiment, as shown in FIG. 5, a server selected the data to be transmitted to a vehicle in response to an obtainment request from the vehicle. In contrast, this embodiment has an arrangement in which a server will provide a vehicle with information obtained from a predetermined range of the vehicle, and the information to be used on the side of the vehicle will be selected by choosing and discarding the received information. That is, this embodiment will describe an arrangement in which the vehicle will preferentially use the peripheral information detected by the detection units of the self-vehicle while complementing the information of each blind spot region by using the peripheral information obtained from the server.

[Processing Sequence]

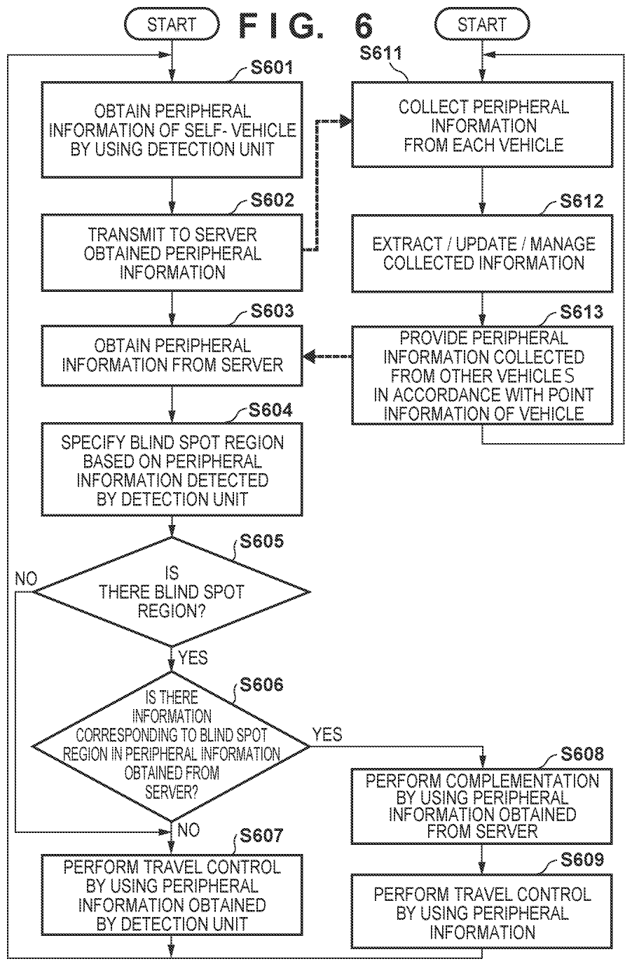

A processing sequence according to this embodiment will be described hereinafter. This processing shows an arrangement to be executed by each vehicle 201 and a server 203. In FIG. 6, processing to be executed by the server 203 is illustrated on the right side, and processing to be executed by each vehicle 201 is illustrated on the left side. A dotted line arrow represents transmission/reception of data in FIG. 6.

Processing performed on the side of the vehicle will be described first. Note that, transmission/reception of data is performed between the plurality of vehicles 201 and the server 203 as shown in FIG. 2, and an example of one vehicle 201 will be described here. Although processing of each vehicle 201 is performed by the cooperation of a plurality of devices such as the ECUs, the communication device, and the like, the vehicle 201 will be denoted as the main subject of processing for the sake of descriptive convenience in this case.

In step S601, the vehicle 201 uses a plurality of detection units included in the self-vehicle to obtain information (peripheral information) of the peripheral environment. The information to be obtained here is not particularly limited and may be changed in accordance with the arrangement of the vehicle.

In step S602, the vehicle 201 transmits, to the server 203, the peripheral information detected in step S601. In this case, peripheral information to be transmitted may be arranged so that all of the pieces of information detected by the detection units will be transmitted or only information detected by a specific unit will be transmitted. It may also be arranged so that the data to be transmitted may be limited in accordance with the data rate and the data amount or important information will be prioritized and sequentially transmitted by setting a priority to the data. The priority setting method is not particularly limited. At this time, position information and information for identifying the self-vehicle and the like may be transmitted together as well.

In step S603, the vehicle 201 obtains, from the server 203, the pieces of peripheral information detected by other vehicles. Note that the obtainment of peripheral information is not limited to this processing, and it may be set so that the peripheral information will be received when, for example, it is determined that a blind spot region is present in step S604 (to be described later). As a result, the data may be obtained at a required timing while suppressing the data reception amount.

In step S604, the vehicle 201 specifies, based on the peripheral information obtained in step S601, each region (blind spot region) that could not be detected by the detection units. In this case, each blind spot region corresponds to a region described with reference to FIG. 3. In addition, information of the range which can be detected by the self-vehicle may be held in advance, and each region outside this range may be handled as a blind spot region. For example, since the detection accuracy of each detection unit will decrease as the distance increases from the installation position of the detection unit, a position that is apart by a predetermined distance from the detection unit may be handled as a blind spot region even if an obstacle is absent.

In step S605, the vehicle 201 determines whether a blind spot region has been specified in step S604. If a blind spot region has been specified (YES in step S605), the process advances to step S606. If a blind spot region has not been specified (NO in step S605), the process advances to step S607.

In step S606, the vehicle 201 determines whether information corresponding to the blind spot region is present in the peripheral information obtained in step S603. If it is determined that the information corresponding to the blind spot region is present (YES in step S606), the process advances to step S608. Otherwise (NO in step S606), the process advances to step S607.

In step S607, the vehicle 201 uses the peripheral information obtained in step S601 to generate information related to travel control. The vehicle 201 uses the generated information to perform travel control of the self-vehicle. Subsequently, the process returns to step S601. Note that this processing sequence will end in a case in which an instruction is made to end the automated driving or the travel support control.

In step S608, the vehicle 201 uses the peripheral information obtained from the server 203 to perform complementation processing on the peripheral information obtained in step S601. For example, the peripheral region of the self-vehicle may be divided into a plurality of regions, and the peripheral information related to a region which includes a blind spot region, among the plurality of regions, may be extracted from the information obtained from the server to perform complementation. In addition, complementation may be performed upon correcting the peripheral information obtained from the server by considering the positional relationship between the self-vehicle and the other vehicles. Note that the complementation method to be used here is not particularly limited, and may be switched in accordance with the processing speed and the range of each blind spot region. In addition, the peripheral information to be used may be switched in accordance with the state.

In step S609, the vehicle 201 uses the peripheral information complemented in step S608 to generate information related to travel control. The vehicle 201 uses the generated information to perform travel control of the self-vehicle. Subsequently, the process returns to step S601. Note that this processing sequence will end in a case in which an instruction is made to end the automated driving or the travel support control.

The processing performed on the side of the server 203 will be described next.

In step S611, the server 203 obtains the peripheral information transmitted from each vehicle.

In step S612, the server 203 extracts the peripheral information collected in step S612 so as to make the peripheral information correspond with a predetermined arrangement, and holds the peripheral information in a database (an external storage device 213). In this case, the holding method is not particularly limited, and may be specified in accordance with the processing speed and the data amount. Also, past peripheral information may be deleted in a case in which a predetermined time has elapsed since the information has been collected.

In step S613, the server 203 transmits the peripheral information corresponding to the neighborhood of the position information included in the peripheral information received from the vehicle. In this case, the information to be transmitted or the transmission order of the information may be determined in accordance with the communication rate and the data amount. Note that the transmission of information may be canceled in the middle of the transmission in accordance with the time (elapsed time) taken for the transmission. In addition, it may be arranged so that the operation state of each roadway will be identified and the peripheral information will be transmitted when each vehicle is set to an automated driving or travel support mode. In this case, although the transmission of peripheral information from the side of the vehicle to the server will be performed when the vehicle is traveling by manual driving, it will be arranged so the peripheral information will not be provided from the side of the server to the vehicle. Subsequently, the process retums to step S611.

Although the vehicle obtained (step S603) the peripheral information at a required timing in the above-described processing, the present invention is not limited to this. For example, the vehicle 201 may include map information, and it may be arranged so that the peripheral information will be held by associating (mapping) the peripheral information with the map information each time the peripheral information is received from the server 203. At this time, it may be arranged so as to discard information for which a predetermined time has elapsed since the reception or to reduce the degree of reliability of this information. In such an arrangement, when a blind spot region is determined to be present in the peripheral regions of the self-vehicle in step S606, travel control will be performed by using the peripheral information associated with the map information at that point. In this manner, it may be arranged to associate the map information and the information provided from the server in advance to reduce the load of the complementation processing at the point in which the presence of a blind spot region is determined.

It is assumed in the above-described processing that, normally, the information of each region that can detected by the self-vehicle will be used for travel control. However, in a case in which the vehicle receives, from the server, the peripheral information of a region that can be detected by the vehicle and the received peripheral information has been set with a high degree of urgency or priority, it may be set so that the peripheral information received from the server will be used for travel control instead of the information detected by the self-vehicle.

According to the arrangement described above, the accuracy of travel control can be improved on the side of the vehicle by providing, to each vehicle, information of each region that could not be detected by the vehicle. In addition, compared to the first embodiment, the response time can be reduced by omitting the extraction processing performed on the side of the server.

### Summary of Embodiments

1. A vehicle (for example, 1) according to the above-described embodiment comprises

a detection unit (for example, 41, 43) configured to detect peripheral information of a periphery of a self-vehicle:

a communication unit (for example, 24, 24c) configured to communicate with an external apparatus;

a specification unit (for example, 22, 23) configured to specify, based on the peripheral information detected by the detection unit, a region that cannot be detected in the periphery of the self-vehicle;

an obtaining unit (for example, 24) configured to obtain, from peripheral information which has been detected by an object and is accumulated in the external apparatus, information of the region specified by the specification unit, via the communication unit; and

a generation unit (for example, 20) configured to generate, by using the peripheral information detected by the detection unit and the information obtained by the obtaining unit, information to perform travel control of the self-vehicle.

According to the embodiment, even in a case in which a region that cannot be detected by a detection unit included in the self-vehicle is present in the periphery, appropriate travel control can be performed by using information detected by other vehicles.

2. In the vehicle according to the above-described embodiment,

the specification unit specifies, based on a positional relationship between the self-vehicle and another vehicle, a region that is hidden by the other vehicle as a region that cannot be detected.

According to the embodiment, a region, which cannot be detected due to another vehicle positioned in the periphery of the self-vehicle, can be specified as a region in which the peripheral information is to be obtained from the server.

3. In the vehicle according to the above-described embodiment,

the specification unit specifies, based on a positional relationship between the self-vehicle and an object, a region that is hidden by the object as a region that cannot be detected.

According to this embodiment, a region that cannot be detected due to an object can be specified as a region in which the peripheral information is to be obtained from the server.

4. In the vehicle according to the above-described embodiment,

the obtaining unit obtains, from the peripheral information accumulated in the external apparatus, peripheral information within a predetermined range from a current position of the self-vehicle.

According to this embodiment, the peripheral information to be obtained from the server can be switched in accordance with the current position of the self-vehicle, and the communication load at the time of the obtainment can be suppressed.

5. In the vehicle according to the above-described embodiment,

the obtaining unit obtains, from the peripheral information accumulated in the external apparatus, peripheral information of a travel path of the self-vehicle that has been set in advance.

According to this embodiment, the peripheral information to be obtained from the server can be switched in accordance with the travel path of the self-vehicle, and the communication load at the time of the obtainment can be suppressed. In addition, the peripheral information along the path can be obtained by using the travel path during automated driving in the automated driving control, and information can be obtained sufficiently.

6. In the vehicle according to the above-described embodiment,

the obtaining unit preferentially obtains peripheral information related to a predetermined type of object.

According to this embodiment, peripheral information with high priority can be received at an earlier stage.

7. In the vehicle according to the above-described embodiment,

the obtaining unit switches, in accordance with a travel state of the self-vehicle, a region from which the peripheral information is to be obtained.

According to this embodiment, the range of peripheral information to be obtained from the server can be switched in accordance with the travel state of the self-vehicle so that peripheral information with high priority can be obtained at an earlier stage while suppressing the communication load.

8. In the vehicle according to the above-described embodiment,

the obtaining unit switches, in accordance with a communication state of the communication unit and a data amount of the peripheral information, the peripheral information to be obtained.

According to this embodiment, the communication load when the peripheral information is to be obtained from the server can be suppressed.

9. In the vehicle according to the above-described embodiment,

the obtaining unit switches, in accordance with a communication state of the communication unit and a positional relationship between the self-vehicle and a region corresponding to the peripheral information, a data format of the peripheral information to be obtained.

According to the embodiment, the communication load when the peripheral information is to be obtained from the server can be suppressed.

10. In the vehicle according to the above-described embodiment,

the obtaining unit further obtains information of the object that detected the peripheral information.

According to the embodiment, travel control can be performed based on information from another vehicle.

11. The vehicle according to the above-described embodiment further comprises:

a transmission unit configured to transmit the peripheral information detected by the detection unit to the external apparatus.

According to the embodiment, it is possible to implement an arrangement in which the peripheral information detected by the self-vehicle can be used by another vehicle via the server.

12. The vehicle according to the above-described embodiment further comprises:

a control unit configured to perform travel control of the vehicle by using the information generated by the generation unit.

According to the embodiment, travel control of the self-vehicle can be performed by using information generated by using the peripheral information detected by the self-vehicle and the peripheral information detected by other vehicles.

13. In the above-described embodiment, an information processing apparatus (for example, 203) comprises:

a collection unit (for example, 215) configured to collect peripheral information from at least one of a plurality of vehicles and a predetermined object;

a holding unit (for example, 213) configured to hold the peripheral information collected by the collection unit; and

a providing unit (for example, 210) configured to provide the peripheral information held by the holding unit to one vehicle of the plurality of vehicles,

wherein the peripheral information provided by the providing unit is information of a region that cannot be detected by detection unit included in the vehicle.

According to the embodiment, pieces of peripheral information detected by a plurality of vehicles can be collected, and the peripheral information related to a region that could not be detected by each vehicle can be provided.

14. In the above-described embodiment, a control method of a vehicle that includes a detection unit configured to detect peripheral information of a periphery of a self-vehicle and a communication unit configured to communicate with an external apparatus comprises:

a specification step of specifying, based on the peripheral information detected by the detection unit, a region that cannot be detected in the periphery of the self-vehicle;

an obtaining step of obtaining, from peripheral information which has been detected by an object and is accumulated in the external apparatus, information of the region specified in the specification step, via the communication unit; and

a generation step of generating, by using the peripheral information detected by the detection unit and the information obtained in the obtaining step, information to perform travel control of the self-vehicle.

According to the embodiment, even in a case in which a region that cannot be detected by a detection unit included in the self-vehicle is present in the periphery, appropriate travel control can be performed by using information detected by other vehicles.

15. In the above-described embodiment, a control method of an information processing apparatus (for example, 203) comprises:

a collection step of collecting peripheral information from at least one of a plurality of vehicles and a predetermined object;

a holding step of holding, in a storage unit (for example, 213), the peripheral information collected in the collection step; and

a providing step of providing the peripheral information held in the storage unit to one vehicle of the plurality of vehicles,

wherein the peripheral information provided in the providing step is information of a region that cannot be detected by detection unit included in the vehicle.

According to this embodiment, pieces of peripheral information detected by a plurality of vehicles can be collected, and the peripheral information related to a region that could not be detected by each vehicle can be provided.

16. In the above-described embodiment, a system is formed by a plurality of vehicles (for example, 201A-201C) and a server (for example, 203),

wherein each of the plurality of vehicles comprises
a detection unit configured to detect peripheral information of a periphery of a self-vehicle,
a communication unit configured to communicate with the server,
a specification unit configured to specify, based on the peripheral information detected by the detection unit, a region that cannot be detected in the periphery of the self-vehicle,
an obtaining unit configured to obtain, from peripheral information which has been detected by an object and is accumulated in the server, information of the region specified by the specification unit, via the communication unit, and
a generation unit configured to generate, by using the peripheral information detected by the detection unit and the information obtained by the obtaining unit, information to perform travel control of the self-vehicle, and

wherein the server comprises
a collection unit configured to collect peripheral information from at least one of the plurality of vehicles and a predetermined object;
a holding unit configured to hole the peripheral information collected by the collection unit; and
a providing unit configured to provide the peripheral information held by the holding unit to one vehicle of the plurality of vehicles,

wherein the peripheral information provided by the providing unit is information of a region that cannot be detected by detection unit included in the vehicle.

According to the embodiment, even in a case in a region that cannot be detected by the detection units included in each vehicle is present in the periphery, each vehicle can perform appropriate travel control by using information detected by other vehicles.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A vehicle comprising:
a detection unit configured to detect peripheral information of a periphery of a self-vehicle;
a communication unit configured to communicate with an external apparatus;
a specification unit configured to specify, based on the peripheral information detected by the detection unit, a region that cannot be detected in the periphery of the self-vehicle;
an obtaining unit configured to obtain, from peripheral information which has been detected by an object and is accumulated in the external apparatus, information of the region specified by the specification unit, via the communication unit; and
a generation unit configured to generate, by using the peripheral information detected by the detection unit and the information obtained by the obtaining unit, information to perform travel control of the self-vehicle.

2. The vehicle according to claim 1, wherein the specification unit specifies, based on a positional relationship between the self-vehicle and another vehicle, a region that is hidden by the other vehicle as a region that cannot be detected.

3. The vehicle according to claim 1, wherein the specification unit specifies, based on a positional relationship between the self-vehicle and an object, a region that is hidden by the object as a region that cannot be detected.

4. The vehicle according to claim 1, wherein the obtaining unit obtains, from the peripheral information accumulated in the external apparatus, peripheral information within a predetermined range from a current position of the self-vehicle.

5. The vehicle according to claim 1, wherein the obtaining unit obtains, from the peripheral information accumulated in the external apparatus, peripheral information of a travel path of the self-vehicle that has been set in advance.

6. The vehicle according to claim 1, wherein the obtaining unit preferentially obtains peripheral information related to a predetermined type of object.

7. The vehicle according to claim 1, wherein the obtaining unit switches, in accordance with a travel state of the self-vehicle, a region from which the peripheral information is to be obtained.

8. The vehicle according to claim 1, wherein the obtaining unit switches, in accordance with a communication state of the communication unit and a data amount of the peripheral information, the peripheral information to be obtained.

9. The vehicle according to claim 1, wherein the obtaining unit switches, in accordance with a communication state of the communication unit and a positional relationship between the self-vehicle and a region corresponding to the peripheral information, a data format of the peripheral information to be obtained.

10. The vehicle according to claim 1, wherein the obtaining unit further obtains information of the object that detected the peripheral information.

11. The vehicle according to claim 1, further comprising:
a transmission unit configured to transmit the peripheral information detected by the detection unit to the external apparatus.

12. The vehicle according to claim 1, further comprising:
a control unit configured to perform travel control of the vehicle by using the information generated by the generation unit.

13. An information processing apparatus comprising:
a collection unit configured to collect peripheral information from at least one of a plurality of vehicles and a predetermined object;
a holding unit configured to hold the peripheral information collected by the collection unit; and
a providing unit configured to provide the peripheral information held by the holding unit to one vehicle of the plurality of vehicles,
wherein the peripheral information provided by the providing unit is information of a region that cannot be detected by detection unit included in the vehicle.

14. A control method of a vehicle that includes a detection unit configured to detect peripheral information of a periphery of a self-vehicle and a communication unit configured to communicate with an external apparatus, the method comprising:
a specification step of specifying, based on the peripheral information detected by the detection unit, a region that cannot be detected in the periphery of the self-vehicle;
an obtaining step of obtaining, from peripheral information which has been detected by an object and is accumulated in the external apparatus, information of the region specified in the specification step, via the communication unit; and
a generation step of generating, by using the peripheral information detected by the detection unit and the information obtained in the obtaining step, information to perform travel control of the self-vehicle.

15. A control method of an information processing apparatus, the method comprising:
a collection step of collecting peripheral information from at least one of a plurality of vehicles and a predetermined object;
a holding step of holding, in a storage unit, the peripheral information collected in the collection step; and
a providing step of providing the peripheral information held in the storage unit to one vehicle of the plurality of vehicles,
wherein the peripheral information provided in the providing step is information of a region that cannot be detected by a detection unit included in the vehicle.

16. A system formed by a plurality of vehicles and a server,
wherein each of the plurality of vehicles comprises
a detection unit configured to detect peripheral information of a periphery of a self-vehicle,
a communication unit configured to communicate with the server,
a specification unit for specifying, based on the peripheral information detected by the detection unit, a region that cannot be detected in the periphery of the self-vehicle,
an obtaining unit configured to obtain, from peripheral information which has been detected by an object and is accumulated in the server, information of the region specified by the specification unit, via the communication unit, and
a generation unit configured to generate, by using the peripheral information detected by the detection unit and the information obtained by the obtaining unit, information to perform travel control of the self-vehicle, and
wherein the server comprises
a collection unit configured to collect peripheral information from at least one of the plurality of vehicles and a predetermined object;
a holding unit configured to hold the peripheral information collected by the collection unit; and
a providing unit configured to provide the peripheral information held by the holding unit to one vehicle of the plurality of vehicles,
wherein the peripheral information provided by the providing unit is information of a region that cannot be detected by detection unit included in the vehicle.
